(19) United States
(12) Patent Application Publication
(10) Pub. No.: US 2011/0256294 A1
(43) Pub. Date: Oct. 20, 2011

(54) METHOD FOR MANUFACTURING OF CUBE SHAPED PROCESSED FISH AND PRODUCT OBTAINED THEREBY

(75) Inventors: Sang Yong LEE, Bucheon Si Gyeonggi-Do (KR); Cheon Woo YOO, Gwangju Si (KR)

(73) Assignee: DONGWON F&B CO., LTD., Seoul (KR)

(21) Appl. No.: 12/951,491

(22) Filed: Nov. 22, 2010

(30) Foreign Application Priority Data
Apr. 16, 2010 (KR) 10-2010-0035069

(51) Int. Cl. A23L 1/325; A23B 4/06; A23P 1/10

(52) U.S. Cl. 426/574

(57) ABSTRACT

A method for manufacturing of a cube shaped processed fish is disclosed, which is fish fillet cut into a plurality of pieces to be conveniently eaten and widely used. The method includes forming viscous emulsion for shaping of fish fillet, forming a mixture of the viscous emulsion and the fish fillet, forming a shaped fish fillet by casting the mixture into a mold, steaming the shaped fish fillet, freezing the steamed shaped fish fillet, and cutting the frozen shaped fish fillet into a predetermined shape. Accordingly, since contents of a processed fish product are cut in advance in a proper size, use, eating, and storage of the product are convenient. Also, an improved appearance of the product may increase consumption desire of consumers.

### CROSS-REFERENCE TO RELATED APPLICATION

This application claims the benefit of Korean Patent Application No. 10-2010-0035069, filed on Apr. 16, 2010, in the Korean Intellectual Property Office, the disclosure of which is incorporated herein by reference.

### BACKGROUND

1. Field of the Invention

The present invention relates to a method for manufacturing of a cube shaped processed fish and a product obtained thereby, and more particularly, to a method for manufacturing of a cube shaped processed fish enabling convenient eating and wide use of fish by cutting the fish into a cube shape and a processed fish product obtained thereby.

2. Description of the Related Art

Generally, fish such as tuna is high-protein low-calorie nutritious food since it contains not only docosahexaenoic acid (DHA), that is, w-3 polyunsaturated fatty acid (PUFA), and a lot of eicosapentaenoic acid (EPA) but also contains selenium which is anticancer, various vitamins and minerals, and amino acids such as histidine and alanine.

Especially, the DHA and the EPA improve brain functions by developing intelligence and, furthermore, effectively prevent adult diseases by dissolving cholesterol which is one of main causes of the adult diseases. The DHA and the EPA are also effective to prevent various diseases related to blood vessels and a circulatory organ, such as arteriosclerosis, hypertension, thrombosis, and the like. In addition, nucleic acid contained in fish prevents aging while iron and vitamin prevent anemia.

However, such fish has been commercialized only in the form of canned products such as canned tuna, mackerel pike, mackerel, and the like. That is, use of processed fish product is limited.

Since fish product processed in the form of can is easy to distribute and store and convenient to eat, consumption of the processed fish product is steadily increasing. However, processed fish product has a limited processing type and therefore is insufficient to meet users' various needs.

Furthermore, in case of conventional canned fish, once the can is opened, residual contents are difficult to store as well as looking unpleasing. That is, it is hard to take out part of the contents from the can and store the rest. Especially when the contents of the canned fish are only partially used for a food such as salad, it is inconvenient to take off a proper amount out of the contents.

Accordingly, there is a desire for a new processed fish product which is convenient to take out part of the contents while achieving easy storage and distribution.

### SUMMARY

An aspect of the present invention provides a method for manufacturing of cube shaped processed fish that is fish fillet cut into pieces and packed so as to overcome limited use of canned fish due to a limited processing type, and a processed fish product obtained thereby.

Another aspect of the present invention provides a processed fish product having a cube shape to improve an appearance of the fish product, give an appetite to users, and increase consumption.

Still another aspect of the present invention provides a method for manufacturing of cube shaped processed fish which is easy to take out a desired amount from the whole contents and store the rest part when used for a food such as salad, and a processed fish product obtained thereby.

According to an aspect of the present invention, there is provided a method for manufacturing of cube shaped processed fish, including forming viscous emulsion for shaping of fish fillet; forming a mixture of the viscous emulsion and the fish fillet; forming a shaped fish fillet by casting the mixture into a mold; steaming the shaped fish fillet; freezing the steamed shaped fish fillet; and cutting the frozen shaped fish fillet into a predetermined shape.

The forming of the viscous emulsion may include mincing which minces raw fish or processed fish solely or together, salt soluble protein eluting which elutes salt soluble protein by adding salt or seasoning liquid; and emulsifying which adds and mixes oil and fat and water to the minced fish from which the salt soluble protein is eluted.

The emulsifying may be performed at an emulsification temperature ranging from about −20 to 30° C.

The mincing, the salt soluble protein eluting, and the emulsifying may be performed sequentially or simultaneously.

The shaped fish fillet may be cut into a plurality of shaped fish fillet pieces by a band saw or a water jet knife. Therefore, a plurality of shaped fish fillet pieces having uniform sizes are generated. The shaped fish fillet may be cut into a plurality of cube shapes.

The method may further include packing the cut shaped fish fillet in a package container; sealing the package container; and sterilizing the package container.

In the sealing, the package container may be made of any one of a multilayered high-molecular compound such as iron, aluminum, poly propylene (PP), and EVOH (ethylene vinyl alcohol), and a multilayer structure made of cellulose such as an aluminum film, and may be shaped as any one of a 2-pieces (DRD) or 3-pieces circular container, a DRD or 3-pieces rectangular container, and a bowl-shape container.

The sterilizing may be performed under a temperature condition of about 100 to 140° C. and a time condition of about 10 to 180 minutes.

According to another aspect of the present invention, there is provided a processed fish product manufactured by mixing a mixture of fish fillet and viscous emulsion, the viscous emulsion formed by mincing raw fish or processed fish solely or together, eluting salt soluble protein by adding salt or seasoning liquid, emulsifying the salt soluble protein eluted fish by adding oil and fat and water and performing an emulsification process at about −20 to 30° C., forming a shaped fish fillet by casting the mixture into a mold, steaming the shaped fish fillet, freezing the steamed shaped fish fillet, cutting the frozen shaped fish fillet into a predetermined shape, packing the plurality of shaped fish fillet pieces in a container, sealing the container, and sterilizing the container at a temperature of about 100 to 140° C. for about 10 to 180 minutes.

The mincing, the salt soluble protein eluting, and the emulsifying in forming of the viscous emulsion may be simultaneously performed.

The plurality of shaped fish fillet pieces may have a cube shape.

### EFFECT

According to embodiments of the present invention, a processed fish product containing fish fillet cut into pieces and packed is achieved. Therefore, the product may be used by a desired amount according to purposes, overcoming the limit of use of conventional canned fish caused by a limited processing type.

Additionally, according to embodiments of the present invention, since the fish fillet is cut into a cube shape, appearance of the fish product is improved while giving an appetite to users. Also, consumption desire of consumers may increase. In other words, the shape of the product may greatly improve the marketability.

Furthermore, when the processed fish product is used for ingredients of food such as salad, it is easy to take off only a desired amount and store the rest part.

In addition, being in the form of separate pieces, the processed fish product is convenient to eat. Therefore, the processed fish product may be used as snack under the influence of a well-being trend of recent days. That is, consumption of the processed fish product may increase.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flow chart schematically illustrating a method for manufacturing of cube shaped processed fish according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

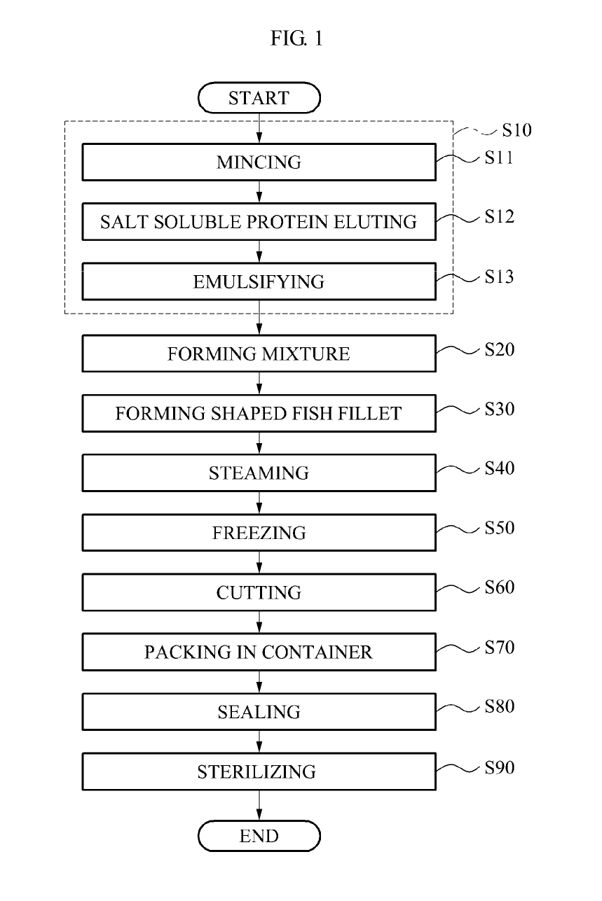

A method for manufacturing of cube shaped processed fish according to the embodiments will be explained as a method for manufacturing of processed and commercially mass-produced fish including tuna, mackerel pike, and mackerel. However, kinds of fish and objective parts of the processing are not specifically limited. FIG. 1 is introduced for a more detailed description.

FIG. 1 is a flowchart schematically illustrating the method for manufacturing cube shaped processed fish according to one embodiment of the present invention.

As shown in FIG. 1, the manufacturing method includes forming a viscous emulsion (operation S10), forming a mixture (operation S20), forming a shaped fish fillet (operation S30), steaming the shaped fish fillet (operation S40), freezing the shaped fish fillet (operation S50), and cutting the shaped fish fillet (operation S60).

First, the viscous emulsion is prepared to shape fish (operation S10). Here, the fish includes raw fish and processed fish and the emulsion refers to fish paste. The forming of the viscous emulsion (fish paste) includes mincing (operation S11), protein eluting (operation S12), and emulsifying (operation S13).

More specifically, raw fish or processed fish is prepared. For example, in a case where the viscous emulsion is prepared to make a proper size of tuna mixture (raw tuna or steam-cooked tuna), it is exemplary to prepare raw fish or processed fish. In case of using other adequate fish, corresponding raw fillet and its processed form may be prepared. The raw fish or processed fish is used solely or together and minced by a silent cutter or a ball cutter (operation S11) to facilitate elution of salt soluble protein. Salt or seasoning liquid is added to the minced fish to elute the salt soluble protein (operation S12). Next, the emulsifying is performed (operation S13) by putting oil and fat and water to the minced fish from which the salt soluble protein is eluted.

In the process of forming the viscous emulsion (fish paste), the mincing, the salt soluble protein eluting using the salt or seasoning liquid, and the emulsifying may be performed sequentially or simultaneously.

Exemplarily, the raw fish or processed fish, the oil and fat, and the water may be emulsified within the temperature range of about −20 to about 30° C. However, the temperature is not specifically limited.

Through the above process, the viscous emulsion mainly containing either or both of the raw fish and the processed fish is manufactured. The viscous emulsion helps the prepared raw fish or processed fish, for example, raw tuna or processed tuna be well mixed and shaped.

Next, the viscous emulsion and prepared fish (raw fish or steamed fish) are mixed by a stirrer (operation S20). As a result, a mixture of the viscous emulsion and the prepared fish is formed.

After the mixture is formed by mixing the viscous emulsion with the prepared fish, the mixture is cast into a predetermined mold, thereby forming a shaped fish fillet (operation S30). A shape of the mold may be determined in consideration of a final processed product to be used for food such as salad. Here, a stuffer or a vacuum stuffer may be used for the forming of the shaped fish fillet. The shaped fish fillet is steamed in a steam cooker or a steam tunnel to maintain its shape (operation S40).

The shaped fish fillet passed through the steaming is frozen to be efficiently cut (operation S50). The freezing may be performed using a tunnel type freezer, a contact type freezer, a screw type freezer, and so forth under proper time and proper temperature conditions according to kinds of the fish to be processed. The mold is removed to perform the cutting. The mold may be removed before the freezing.

When the frozen shaped fish fillet is prepared and the mold is removed, the frozen shaped fish fillet is cut into a predetermined shape (operation S60). The cutting may be performed manually or, more exemplary, by a programmed machine. Exemplarily, the fish fillet is cut into a plurality of pieces in a different shape from general canned fish including canned tuna, canned mackerel pike, mackerel and so forth. In other words, it is exemplary that the final processed product is in the form of a plurality of small pieces in any of a hexahedral shape, a cube shape, a spherical shape, and so forth. The processed fish product in such shapes can be used for various food and various purposes. Also, eating of the product and storage of residual contents become easier.

The cutting will be described in further detail with reference to an example where the final processed product has a cube shape. First, the shaped fish fillet steamed and frozen in the mold is cut into a plurality of layers, that is, a plurality of plates. The plates are cut into strips having uniform widths and the strips are further cut into a plurality of the shaped fish fillet pieces. The shaped fish fillet pieces each have a cube shape in a bite size of about 10 to 20 mm thickness. However the size is not limited thereto.

A band saw or a water jet knife may be used for the cutting.

According to the embodiment of the present invention, the method for manufacturing of the cube shaped processed fish includes packing in a container (operation S70), sealing (operation S80), and sterilizing (operation S90).

The plurality of shaped fish fillet pieces generated by the cutting are packed in a predetermined container (operation S70). Here, the fish fillet pieces may be sorted by size, shape, and so forth, and accordingly packed in different containers. Also, the fish fillet pieces may be packed by different numbers and accordingly allocated with different prices for distribution and sale. After the container is charged with the plurality of fish fillet pieces, appropriate liquids such as vegetable oil, salt water, or seasoning liquid may be put in the container according to kinds of the fish fillet.

The container charged with the fish fillet is sealed (operation S80). Here, the material of the container includes any one of a multilayered high-molecular compound such as iron, aluminum, poly propylene (PP), and EVOH (ethylene vinyl alcohol), and a multilayer structure made of cellulose such as an aluminum film. Also, the container may be shaped as any one of a 2-pieces (DRD) or 3-pieces circular container, a DRD or 3-pieces rectangular container, and a bowl-shape container. However, the material and the shape of the container are not limited thereto.

Exemplarily, an inside of the container is under vacuum during the sealing.

The sealed container goes through the sterilizing process using a sterilizer so that contents of the container are sterilized (operation S90). The sterilizing is performed under a temperature condition of about 100 to 140° C. and a time condition of about 10 to 180 minutes although not limited thereto. The conditions may vary corresponding to the contents and be subdivided according to shapes of the container. Germs that produce toxins or deteriorate the contents can be killed or inactivated by high temperature sterilization. Exemplarily, the sterilization process is performed through a system programmed to control time and temperature.

After the sterilization is performed, the processed product is labeled, packed in a box, and then delivered.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for manufacturing of cube shaped processed fish, comprising:
forming viscous emulsion for shaping of fish fillet;
forming a mixture of the viscous emulsion and the fish fillet;
forming a shaped fish fillet by casting the mixture into a mold;
steaming the shaped fish fillet;
freezing the steamed shaped fish fillet; and
cutting the frozen shaped fish fillet into a predetermined shape.

2. The method of claim 1, wherein the forming of the viscous emulsion comprises:
mincing which minces raw fish or processed fish solely or together;
salt soluble protein eluting which elutes salt soluble protein by adding salt or seasoning liquid; and
emulsifying which adds and mixes oil and fat and water to the minced fish from which the salt soluble protein is eluted.

3. The method of claim 2, wherein the emulsifying is performed at an emulsification temperature ranging from about −20 to 30° C.

4. The method of claim 2, wherein the mincing, the salt soluble protein eluting, and the emulsifying are sequentially performed.

5. The method of claim 2, wherein the mincing, the salt soluble protein eluting, and the emulsifying are simultaneously performed.

6. The method of claim 1, wherein the shaped fish fillet is cut into a plurality of shaped fish fillet pieces by a band saw or a water jet knife.

7. The method of claim 1, wherein the shaped fish fillet is cut into a plurality of cube shapes.

8. The method of claim 1, further comprising:
packing the cut shaped fish fillet in a package container;
sealing the package container; and
sterilizing the package container.

9. The method of claim 8, wherein, in the sealing, the package container is made of any one of a multilayered high-molecular compound such as iron, aluminum, poly propylene (PP), and EVOH (ethylene vinyl alcohol), and a multilayer structure made of cellulose such as an aluminum film, and is shaped as any one of a 2-pieces (DRD) or 3-pieces circular container, a DRD or 3-pieces rectangular container, and a bowl-shape container.

10. The method of claim 8, wherein the sterilizing is performed under a temperature condition of about 100 to 140° C. and a time condition of about 10 to 180 minutes.

11. A processed fish product manufactured by mixing a mixture of fish fillet and viscous emulsion, the viscous emulsion formed by mincing raw fish or processed fish solely or together, eluting salt soluble protein by adding salt or seasoning liquid, emulsifying the salt soluble protein eluted fish by adding oil and fat and water and performing an emulsification process at about −20 to 30° C., forming a shaped fish fillet by casting the mixture into a mold, steaming the shaped fish fillet, freezing the steamed shaped fish fillet, cutting the frozen shaped fish fillet into a predetermined shape, packing the plurality of shaped fish fillet pieces in a container, sealing the container, and sterilizing the container at a temperature of about 100 to 140° C. for about 10 to 180 minutes.

12. The processed fish product of claim 11, wherein the mincing, the salt soluble protein eluting, and the emulsifying in forming of the viscous emulsion are simultaneously performed.

13. The processed fish product of claim 11, wherein the plurality of shaped fish fillet pieces have a cube shape.

14. The method of claim 2, wherein the shaped fish fillet is cut into a plurality of shaped fish fillet pieces by a band saw or a water jet knife.

15. The method of claim 2, wherein the shaped fish fillet is cut into a plurality of cube shapes.

16. The method of claim 2, further comprising:
packing the cut shaped fish fillet in a package container;
sealing the package container; and
sterilizing the package container.
